(19) United States
(12) Patent Application Publication
(10) Pub. No.: US 2018/0298861 A1
(43) Pub. Date: Oct. 18, 2018

(54) Piezoelectric Injector for Fuel Injection

(71) Applicant: Continental Automotive GmbH, Hannover (DE)

(72) Inventors: Gerd Schmutzler, Tegernheim (DE); Christoph Heukenroth, Berlin (DE)

(73) Assignee: Continental Automotive GmbH, Hannover (DE)

(21) Appl. No.: 15/767,449

(22) PCT Filed: Oct. 10, 2016
(86) PCT No.: PCT/EP2016/074182

§ 371 Date: Apr. 11, 2018

(30) Foreign Application Priority Data
Oct. 14, 2015 (DE) 10 2015 219 912.6

(51) Int. Cl. F02M 63/00; F02M 61/16; F02M 61/08

(52) U.S. Cl. CPC F02M 63/0026; F02M 61/167; F02M 2200/708; F02M 63/0033; F02M 63/0077; F02M 61/08

(57) ABSTRACT

The present disclosure relates to internal combustion engines. Various embodiments thereof may include a piezo injector for fuel injection. For example, an injector may include: a nozzle unit with a nozzle needle; a piezoelectric actuator unit; and a hydraulic coupler unit coupling the nozzle unit to the actuator unit. The coupler unit includes a coupler piston, a coupler cylinder, and a coupler spring. The coupler piston has a top side facing toward the coupler cylinder and a bottom side. The coupler spring pushes the coupler piston against a face side of the nozzle needle oriented toward the bottom side of the coupler piston and has a contact area with the nozzle needle. The coupler piston includes a passage opening providing a flow connection from the bottom side of the coupler piston to the top side of the coupler piston, arranged within the contact area.

### CROSS-REFERENCE TO RELATED APPLICATIONS

This application is a U.S. National Stage Application of International Application No. PCT/EP2016/074182 filed Oct. 10, 2016, which designates the United States of America, and claims priority to DE Application No. 10 2015 219 912.6 filed Oct. 14, 2015, the contents of which are hereby incorporated by reference in their entirety.

### TECHNICAL FIELD

The present disclosure relates to internal combustion engines. Various embodiments thereof may include a piezo injector for fuel injection, in particular for direct fuel injection into a combustion chamber or piston of an internal combustion engine.

### BACKGROUND

DE 10 2013 219 225 A1 describes a piezo injector for direct fuel injection, including a hydraulic coupler unit between the piezo actuator and the nozzle needle. The hydraulic coupler has a coupler piston, a coupler cylinder, and a coupler spring. The coupler piston is pressed by means of the coupler spring against a face side, facing toward the coupler piston, of the nozzle needle. In a piezo injector of said type, the filling and the pressure equalization of the coupler volume are ensured by means of the pairing clearance between coupler piston and coupler cylinder. The pairing clearance is configured to be as small as possible in order that the coupler holds the needle stroke approximately constant over an actuation time of up to 5 ms. However, in the case of such a small pairing clearance, the pressure equalization between the coupler volume and the surrounding fuel volume takes a certain length of time, which, depending on the time duration until the next injection process, results in influencing of the coupler function with regard to the transmitted stroke. It may thus be the case that the coupler volume between coupler cylinder and coupler piston cannot be filled quickly enough.

It has, in part, already been sought to achieve faster filling of the coupler volume after an injection process by forming a bore with a check valve in the coupler piston or in the coupler cylinder. This is however cumbersome. Furthermore, this can lead to problems with undesired resonance at the valve.

### SUMMARY

The teachings of the present disclosure include a piezo injector which is reliable and simultaneously robust even in the case of multiple injections. For example, a piezo injector (1) for fuel injection may include: a nozzle unit (3) with a nozzle needle (5) arranged movably in a nozzle body (7); a piezoelectric actuator unit (9); and a hydraulic coupler unit (11) for coupling the nozzle unit (3) to the actuator unit (9). The coupler unit has a coupler piston (13), a coupler cylinder (15), and a coupler spring (17). The coupler piston (13) has a top side (26) facing toward the coupler cylinder (15) and has a bottom side (28) facing toward the nozzle needle (5). The coupler piston (13) is pushed by the coupler spring (17) against a face side (23), facing toward the bottom side (28) of the coupler piston (13), of the nozzle needle (5) and has a contact area (21) with the nozzle needle (5). The coupler piston (13) has a passage opening (25) which provides a flow connection from the bottom side (28) of said coupler piston to the top side (26) of said coupler piston and which is arranged within the contact area (21) with the nozzle needle (5).

In some embodiments, the passage opening (25) extends through the coupler piston (13) from a mouth at the top side (26) to a mouth at the bottom side (28), and the mouth of the passage opening (25) arranged at the bottom side (28) can be closed off by means of the face side (23) of the nozzle needle (5).

In some embodiments, the passage opening (25) can be fully sealed off by the nozzle needle (5).

In some embodiments, the contact area (21) is of planar form.

In some embodiments, the contact area (21) is of concave or convex form.

In some embodiments, the face side (23), facing toward the bottom side (28) of the coupler piston, of the nozzle needle (5) is of planar form.

In some embodiments, the face side (23), facing toward the bottom side (28) of the coupler piston, of the nozzle needle (5) is of convex or concave form.

In some embodiments, the face side (23) and/or the contact area (21) is of spherical form.

In some embodiments, the face side (23) and/or the contact area (21) is of conical form.

In some embodiments, the nozzle needle (5) is of outwardly opening design.

In some embodiments, in the hydraulic coupler unit (11), a fuel film with a thickness in the range from 0.01 mm to 0.7 mm is arranged, for the purposes of force transmission, between the coupler cylinder (15) and the coupler piston (13).

In some embodiments, a lateral pairing clearance between coupler cylinder (15) and coupler piston (13) amounts to at most 10 μm.

### BRIEF DESCRIPTION OF THE DRAWINGS

Various embodiments of the present disclosure will be discussed in more detail below with reference to schematic drawings.

FIG. 1 shows a longitudinal section through a piezo injector according to teachings of the present disclosure;

FIG. 2 shows a longitudinal section through a piezo injector according to teachings of the present disclosure;

FIG. 3 shows a longitudinal section through a piezo injector according to teachings of the present disclosure;

FIG. 4 shows a longitudinal section through a piezo injector according to teachings of the present disclosure;

FIG. 5 shows a detail of a piezo injector according to teachings of the present disclosure;

FIG. 6 shows a detail of a piezo injector according to teachings of the present disclosure;

FIG. 7 shows a detail of a piezo injector according to teachings of the present disclosure;

FIG. 8 shows a detail of a piezo injector according to teachings of the present disclosure;

FIG. 9 shows a detail of a piezo injector according to teachings of the present disclosure;

FIG. 10 shows a detail of a piezo injector according to teachings of the present disclosure;

FIG. 11 shows a detail of a piezo injector according to teachings of the present disclosure;

FIG. 12 shows a detail of a piezo injector according to teachings of the present disclosure; and

FIG. 13 shows a detail of a piezo injector according to teachings of the present disclosure.

### DETAILED DESCRIPTION

In some embodiments, a piezo injector for fuel injection comprises a nozzle unit with a nozzle needle arranged movably in a nozzle body, a piezoelectric actuator unit, and a hydraulic coupling unit for coupling the nozzle unit to the actuator unit. The hydraulic coupling unit has a coupler piston, a coupler cylinder and a coupler spring.

The coupler piston has a top side facing toward the coupler cylinder and a bottom side facing toward the nozzle needle. In some embodiments, the coupler cylinder is open toward the nozzle needle, such that the coupler piston is exposed. At the side averted from the nozzle needle, the coupler cylinder has a base. The statement that the top side of the coupler piston faces toward the coupler cylinder means that the top side faces toward the base of the coupler cylinder. In some embodiments, the coupler volume is formed between the base of the coupler cylinder and the top side of the coupler piston.

The coupler piston is pushed by means of the coupler spring against a face side, facing toward the bottom side of the coupler piston, of the nozzle needle and has a contact area with the nozzle needle. The coupler piston has a passage opening which provides a flow connection from the bottom side of said coupler piston to the top side of said coupler piston and which is arranged within the contact area with the nozzle needle.

In some embodiments, the passage opening extends through the coupler piston from a mouth at the top side to a mouth at the bottom side. Here, the statement that the passage opening is arranged within the contact area with the nozzle needle means that the mouth of the passage opening arranged at the bottom side entirely overlaps the nozzle needle in a plan view of the face side. In some embodiments, the face side of the nozzle needle and the bottom side of the coupler piston are designed and arranged such that the mouth of the passage opening arranged at the bottom side can be closed off by means of the face side of the nozzle needle.

In some embodiments, the piezoelectric actuator unit is mechanically connected, rigidly connected, to the coupler cylinder, such that a change in length of the piezoelectric actuator unit causes a displacement of the coupler cylinder along a longitudinal axis. By means of the fluid contained in the coupler volume, an axial force can thus be transmitted to the coupler piston, which force is transmitted by said coupler piston, by means of its form-fitting contact, as an actuating force to the valve needle to move the valve needle from the closed position toward an open position.

In some embodiments, filling of the coupler volume through the passage opening in the coupler piston is made possible when the nozzle needle is lifted off from the bottom side of the coupler piston and thus opens up the passage opening. This is typically the case after the end of injection, wherein the compensator spring is, taking into consideration the pressurized surface on the piston, designed to be sufficiently weak that such a state with low force between piston and nozzle needle takes effect after the end of injection.

Since leakage of fuel out of the coupler volume has occurred for the duration of the injection, the axial spacing between the coupler piston and coupler cylinder—in particular the spacing between the top side of the coupler piston and the base of the coupler cylinder—has decreased, such that an axial gap forms between the nozzle needle and the coupler piston. Here, the expression “axial” relates to the common longitudinal axis of coupler cylinder, coupler piston and nozzle needle. The needle has thus been lifted off from the coupler piston. The inflow of fuel into the coupler volume can take place.

A rapid pressure equalization in the coupler volume thus takes place after the end of injection. Accordingly, the function of the hydraulic coupler unit is no longer dependent on the time interval between the injections, but is available again very quickly.

Furthermore, the passage opening in the coupler piston improves the ease of filling of the coupler volume after initial assembly or in the event of servicing after an exchange of the injector. The hydraulic coupler unit is arranged on the nozzle body, and the coupler volume can be filled by means of the fuel flowing through the nozzle body to the fuel outlet.

Despite a small pairing clearance, which permits a constant needle stroke over an actuation time of up to 5 ms, the pressure equalization in the coupler volume can thus take place quickly. In the present context, the pairing clearance is to be understood to mean the lateral pairing clearance—in particular between an encircling side wall of the coupler cylinder and the outer surface of the coupler piston.

A contact area of the coupler piston with the nozzle needle is to be understood here and below to mean an area on the surface of the coupler piston, on its bottom side facing toward the nozzle needle, which is contacted by the nozzle needle. Depending on the geometry of the coupler piston and of the nozzle needle, the contact may also be realized along a line, a circular line, such that a sealing edge forms between the coupler piston and the nozzle needle. The contact area is then understood to mean that surface of the coupler piston which is enclosed by said line.

The passage opening in the coupler piston can typically be fully sealed off by the nozzle needle. The passage opening thus forms, together with the nozzle needle, a valve which opens when a gap remains between the coupler piston and nozzle needle at the end of injection as a result of the leakage of fuel from the coupler volume.

There are numerous possibilities for the design of the geometry of the coupler piston and face side of the nozzle needle. In some embodiments, the contact area and the face side of the nozzle needle may be of planar, convex or concave form. These different types of design, and the combination thereof, influence the inflow behavior of fuel. In particular, by means of the diameter of a sealing edge between piston and nozzle needle, the radial flow area available for the pressure equalization can be made larger or smaller independently of the diameter of the passage opening itself. It is furthermore possible, by means of a suitable design of the contact areas between nozzle needle and piston, for centering and/or angular compensation of both components relative to one another to be permitted.

A contact area of planar form and a face side of the nozzle needle of planar form may have a straightforward production process. A contact area of concave form together with a face side of convex form, or conversely a contact area of convex form in conjunction with a face side of concave form, allow centering of the coupler piston and nozzle needle. The face side and/or the contact area may comprise of spherical or conical form.

In some embodiments, the nozzle needle is of outwardly opening design. For this purpose, the needle seat of the nozzle needle may be formed as a conical shell surface which, in the nozzle body, is pushed against a hollow conical surface, such that a sealing function is realized.

In some embodiments, in the hydraulic coupler unit, a fuel film with a thickness in the range from 0.01 mm to 0.7 mm forms between the coupler cylinder and the coupler volume. In particular, the fuel film constitutes the coupler volume. The fuel film is arranged between the top side of the coupler piston and the base of the coupler cylinder. The thickness of the fuel film is selected to be as small as possible, such that the hydraulic coupler has the highest possible stiffness. The minimum thickness of the layer is determined by the required assembly tolerances and by the differences in the changes in length between the piezoelectric actuator and the injector body in the event of temperature changes owing to the different coefficients of thermal expansion between the piezoelectric actuator and the material of the injector body, e.g. steel.

In some embodiments, the pairing clearance, in particular the lateral pairing clearance, between the coupler cylinder and coupler piston amounts to at most 10 μm, in particular at most 2 μm. With such a small pairing clearance, it is ensured that the hydraulic coupler unit holds the needle stroke approximately constant over an actuation time of up to 5 ms.

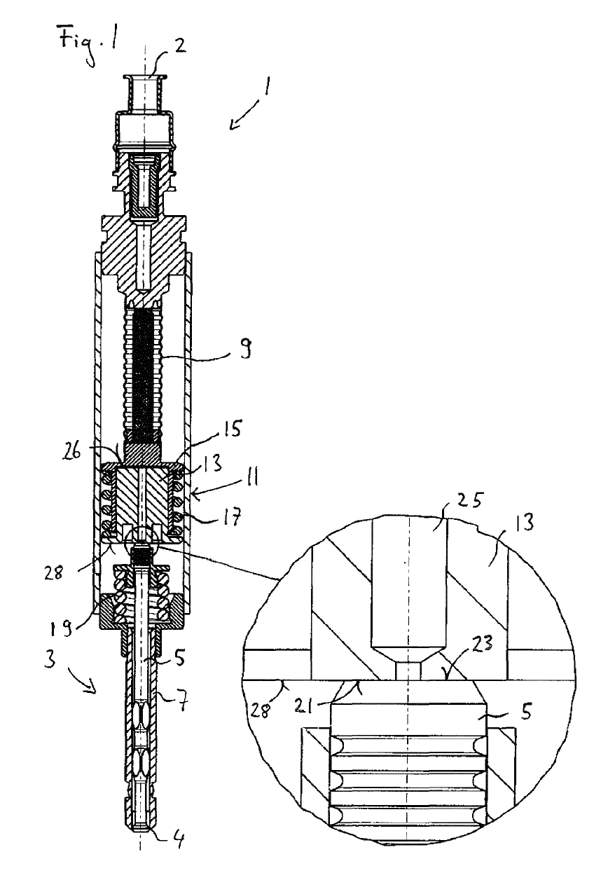

The piezo injector 1 as per FIG. 1 is, in the embodiment shown, designed for the direct injection of fuel into an internal combustion engine. Said piezo injector has a fuel inlet 2 and a fuel outlet 4. In the closed state of the piezo injector 1, the fuel outlet 4 is closed off by means of the nozzle needle 5. For the injection, the nozzle needle 5 opens outwardly and thus opens the fuel outlet 4. The nozzle needle 5 is part of the nozzle unit 3 and is movable in a nozzle body 7 along a longitudinal axis of the piezo injector.

In some embodiments, actuation of the nozzle needle 5 is performed by a piezoelectric actuator unit 9, which utilizes the change in length of a stack composed of piezoelectric ceramic disks: By applying a voltage, a length expansion of the stack of piezoelectric ceramic disks is effected, which causes a displacement of the coupler cylinder 15 in the direction of the coupler piston 13.

The transmission of the force from the actuator unit 9 to the nozzle needle 5 is performed by a hydraulic coupler unit 11. The coupler unit 11 comprises the coupler piston 13, which is mounted in the coupler piston 15 to be movable along the longitudinal axis of the piezo injector 1. The coupler piston 13 is pushed by means of the coupler spring 17 against a face side 23, facing toward the coupler piston 13, of the nozzle needle 5. In this way, a practically play-free transmission of force from the piezoelectric actuator unit 9 via the hydraulic coupler unit 11 to the nozzle needle 5 is ensured: A fuel volume—the coupler volume—is arranged between the coupler piston 13 and the coupler cylinder 15, which fuel volume, owing to the very small clearance, cannot escape if it is displaced as a result of a movement of the coupler cylinder 15. The coupler piston 13 therefore follows the movement of the coupler cylinder 15 and pushes the nozzle needle 5 out of its sealing seat.

Since the resultant force of nozzle spring force, pressure force on the sealing seat diameter and coupler spring force must be overcome for the actuation of the nozzle needle 5, the pressure in the coupler volume is subsequently no longer equal to the pressure in the injector, but rather exceeds the latter. Therefore, in the case of relatively long actuation durations, a leakage of fluid from the coupler volume into the surrounding injector volume would occur, such that the coupler piston 13 would sink in the direction of the coupler volume. The nozzle needle 5 would follow this movement. The fluid leakage and the sinking movement can be reduced by means of as small a sealing gap as possible between coupler piston 13 and coupler cylinder 15.

At the end of an injection, the piezoelectric actuator unit 9 is discharged, and the stack of piezoelectric ceramic disks shortens again to its initial length. The coupler cylinder 15 follows this movement. The coupler volume insulated by the small sealing gap cannot become larger, such that the coupler piston 13 follows the movement of the coupler cylinder 15.

Since the top side of the nozzle needle 5 is no longer acted on by an actuating force, the nozzle needle 5 likewise follows the backward movement, and passes back to its sealing seat. Since, as described above, a leakage from the coupler volume has occurred for the duration of the injection, the axial spacing between coupler piston 13 and coupler cylinder 15 has decreased. Therefore, the initial situation, in which the nozzle needle 5 and the coupler piston 13 are in contact with one another, is not re-attained. An axial gap rather remains between said two components. As described below, said gap is utilized, together with a passage opening through the coupler piston 13, for the refilling of the coupler volume. Refilling would otherwise be possible only through the sealing gap, which is however designed to be as small as possible for the reasons stated above. Therefore, a considerably greater length of time would elapse before the coupler volume is refilled again to such an extent that the coupler piston 13 and nozzle needle 5 are in contact with one another again.

The contact region between the coupler piston 13 and the nozzle needle 5 is shown in detail in the right-hand half of FIG. 1. The coupler piston 13 has a contact area 21 with the nozzle needle 5, which constitutes a partial region of the bottom side 28 and which is planar in the embodiment shown. The face side 23 of the nozzle needle 5 is likewise planar. Into the coupler piston 13 there is formed a passage opening 25 in the form of a passage bore, which passage opening extends through the coupler piston 13 from a mouth at the bottom side 28 of said coupler piston, at which the latter is in contact with the nozzle needle 5, to a mouth at the top side 26 of said coupler piston, and which passage opening provides a flow connection for fuel from the bottom side 28 of said coupler piston to the top side 26 of said coupler piston. Between the top side 26 of the coupler piston 13 and a bottom side—the base—of the coupler cylinder 15, the coupler volume is arranged in the form of a fuel film. Through the passage opening 25, when the nozzle needle 5 has been lifted off from the contact area 21, fuel can flow into the coupler volume and fill the latter, whereby a pressure equalization between the coupler volume and the remaining fuel volume within the piezo injector is ensured.

During operation, the piezo injector opens outward for a fuel injection, by virtue of the nozzle needle 5 being actuated by the actuator unit 9. Here, the transmission of force from the actuator unit 9 to the nozzle needle 5 is performed by means of the hydraulic coupler unit 11. For this purpose, a thin fuel layer with a thickness of between 0.05 mm and 0.3 mm is situated between the top side 26 of the coupler piston 13 and the coupler cylinder 15.

By means of the fuel layer, a force is transmitted hydraulically from the actuator unit 9 acting on the coupler cylinder 15 to the coupler piston 13. Said coupler piston, by means of the form-fitting connection of its contact area 21 to the face side 23 of the nozzle needle 5, transmits the force transmitted to it onward to the nozzle needle 5.

If the force on the nozzle needle 5 provided by the actuator unit 9 exceeds the closing force provided by the nozzle spring 19, the nozzle needle 5 is moved downward, and the piezo injector 1 opens outward. Fuel flows to the outside through the fuel outlet 4. During this opening phase, the pressure in the coupler volume increases owing to the force exerted by the coupler cylinder 15.

In the subsequent closing phase of the piezo injector, the force provided by the actuator unit 9 decreases to zero. The nozzle spring 19 pushes the nozzle needle 5 back upward into its closed position. Since the coupler spring 17 is designed to be sufficiently weak, there is a gap between the coupler cylinder 15 and the coupler piston 13 after the end of injection. The coupler piston 13 has been lifted off from the nozzle needle 5. The passage opening 25 is thereby opened up, and fuel can flow from the fuel volume within the piezo injector 1 into the coupler volume between coupler cylinder 15 and coupler piston 13.

When the coupler volume has been refilled, the gap closes and the coupler piston 13 is, owing to the force exerted by the coupler spring 17, pressed against the face side 23 of the nozzle needle 5 again, and the passage opening 25 is closed off by the nozzle needle 5.

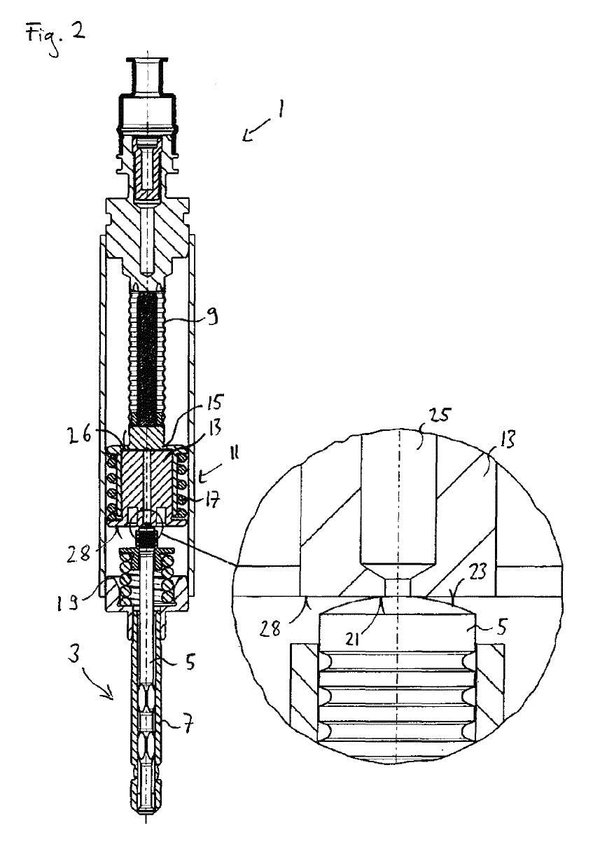

FIG. 2 shows a second embodiment of the piezo injector 1. This embodiment differs from the first embodiment shown in FIG. 1 in that the face side 23 of the nozzle needle 5 is of convex form. In some embodiments, there is contact between the convex face side 23 and the coupler piston 13 with its planar bottom side 28 only in a ring-shaped region around the passage opening 25. In this embodiment, a certain centering action of the nozzle needle 5 in relation to the passage opening 25 is possible.

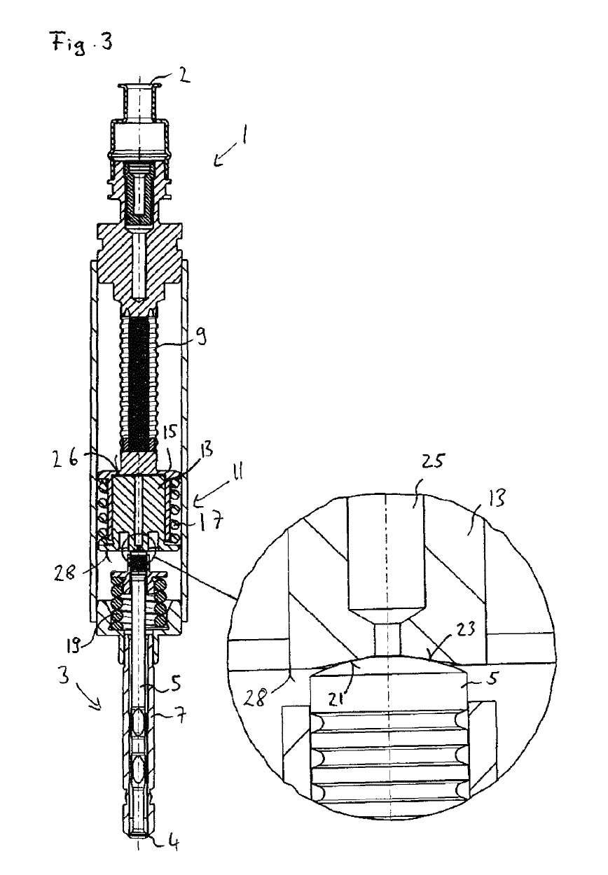

FIG. 3 schematically shows a piezo injector 1 according to the teachings of the present disclosure. This embodiment differs from that shown in FIGS. 1 and 2 in that the face surface 23 of the nozzle needle 5 is of spherically convex form, and the contact area 21 of the coupler piston 13 is conically concave. Here, the radius of curvature of the face surface 23 is smaller than that of the contact area 21. It would also be possible for both areas to be of spherical or conical form. The radial filling gap can be set by means of a variation of the contact diameter. With this embodiment, good centering of the nozzle needle 5 in relation to the passage opening 25, and thus also in relation to the coupler piston 13, is realized.

FIG. 4 shows a piezo injector 1 according to the teachings of the present disclosure. This embodiment differs from the embodiments shown in the previous figures in that the contact area 21 of the coupler piston 13 is concave, and the face side 23 of the nozzle needle 5 is planar. In some embodiments, the nozzle needle 5 makes contact with the coupler piston 13 only in a circular region at the edge of the latter. In this embodiment, there is a relatively large radial flow area available for the pressure equalization.

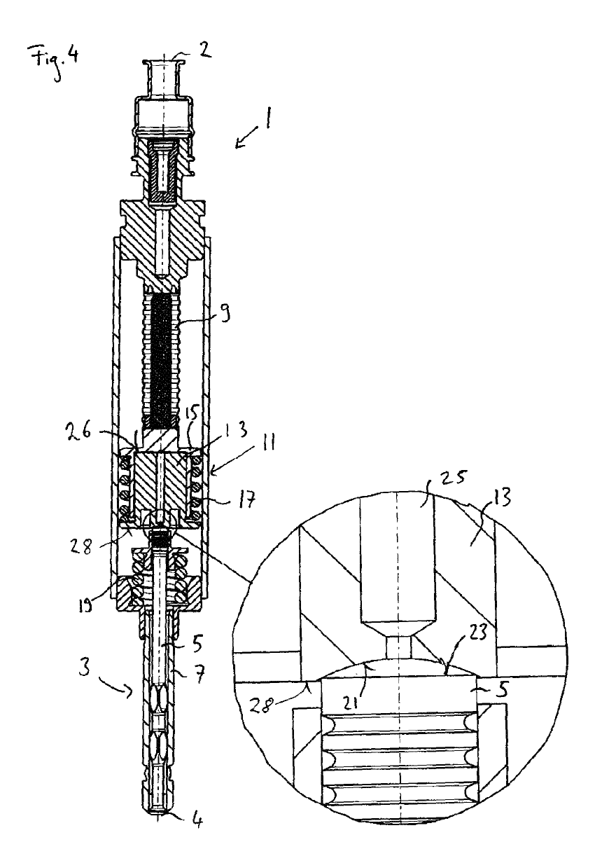

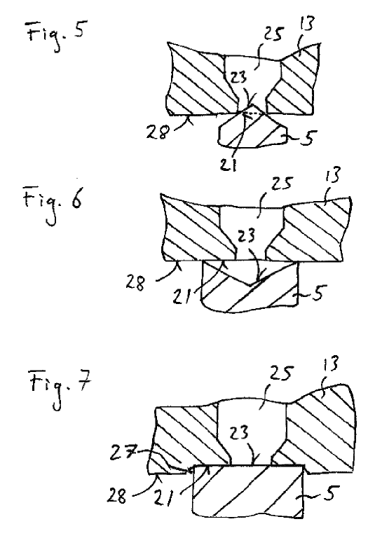

FIG. 5 schematically shows a detail of a piezo injector 1 according to teachings of the present disclosure. In this embodiment, the contact area 21 of the coupler piston 13 is of planar form, but the face side 23 of the nozzle needle 5 is convex, specifically in the form of a cone tip projecting into the passage opening 25. In this embodiment, centering of the nozzle needle 5 is realized.

FIG. 6 shows details of a piezo injector 1 according to teachings of the present disclosure. In this embodiment, the contact area 21 of the coupler piston 13 is of planar form, but the face side 23 of the nozzle needle is concave, specifically in the form of a hollow cone. It could also be of spherical form. In this embodiment, although no centering of the nozzle needle 5 is realized, a relatively large radial flow area is realized.

FIG. 7 shows a detail of a piezo injector 1 according to the teachings of the present disclosure. In this embodiment, similarly to the situation shown in FIG. 1, both the contact area 21 of the coupler piston 13 and the face surface 23 of the nozzle needle 5 are of planar form. However, by contrast to the first embodiment as per FIG. 1, centering of the nozzle needle 5 relative to the coupler piston 13 is provided, specifically in the form of a recess 27 in the coupler piston 13, which recess is entered by the nozzle needle 5.

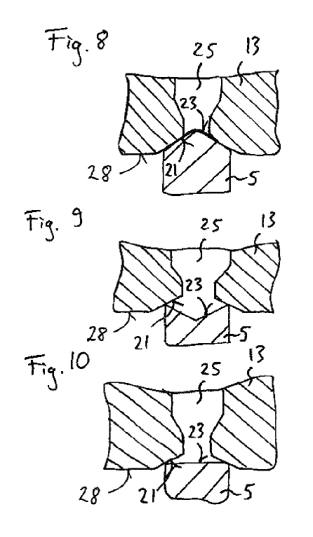

FIGS. 8 to 10 show details of piezo injectors 1 according to teachings of the present disclosure, in each of which the contact areas 21 of the coupler piston 13 are of concave form, specifically in the form of a hollow cone. In the embodiment as per FIG. 8, the face surface 23 of the nozzle needle 5 is simultaneously of convex form, specifically in the shape of a cone, the opening angle of which is exactly adapted to that of the hollow cone of the contact area 21, such that good centering is realized. In the embodiment as per FIG. 9, the face surface 23 is of concave form, specifically in the form of a hollow cone. It could however also be of spherical form. In the embodiment as per FIG. 10, the face surface 23 of the nozzle needle 5 is of planar form.

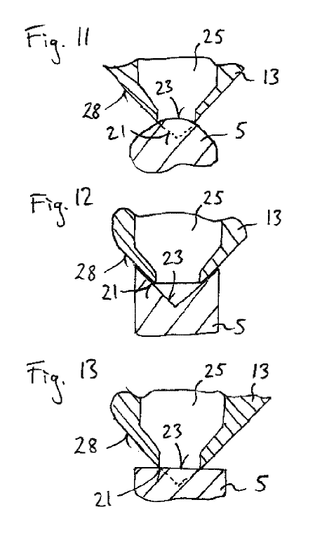

FIGS. 11 to 13 show details of piezo injectors 1 according to teachings of the present disclosure, in each of which the contact area 21 of the coupler piston 23 is of convex form, specifically in the form of a cone. The contact areas 21 could also be of spherical form. In the embodiment as per FIG. 11, the face side 23 of the nozzle needle 5 is of convex form, specifically spherical form. It could also have a conical form. In the embodiment as per FIG. 12, the face surface 23 of the nozzle needle 5 is of concave form, specifically in the form of a hollow cone. It could also be formed in the manner of a hollow cone. In the embodiment as per FIG. 13, the face surface 23 of the nozzle needle is of planar form.

The individual embodiments may differ merely by the geometry of the contact area 21 of the coupler piston 13 and of the face side 23 of the nozzle needle 5. With the different geometries, the radial flow areas available for the pressure equalization can be adapted to the requirements. Furthermore, in accordance with requirements, a centering and/or angular compensation of nozzle needle and coupler piston with respect to one another can be made possible.

What is claimed is:

1. A piezo injector for fuel injection, the injector comprising:
a nozzle unit with a nozzle needle movable within a nozzle body;
a piezoelectric actuator unit; and
a hydraulic coupler unit coupling the nozzle unit to the actuator unit;
wherein the coupler unit includes a coupler piston, a coupler cylinder, and a coupler spring;
wherein the coupler piston has a top side facing toward the coupler cylinder and a bottom side facing toward the nozzle needle;
wherein the coupler spring pushes the coupler piston against a face side of the nozzle needle oriented toward the bottom side of the coupler piston and has a contact area with the nozzle needle;
wherein the coupler piston includes a passage opening providing a flow connection from the bottom side of the coupler piston to the top side of the coupler piston, arranged within the contact area.

2. The piezo injector as claimed in claim 1, wherein the passage opening extends through the coupler piston from a first mouth at the top side to a second mouth at the bottom side; and
the second mouth can be closed off by the face side of the nozzle needle.

3. The piezo injector as claimed in claim 1, wherein the passage opening can be fully sealed off by the nozzle needle.

4. The piezo injector as claimed in claim 1, wherein the contact area comprises a planar surface.

5. The piezo injector as claimed in claim 1, wherein the contact area comprises a concave or convex surface.

6. The piezo injector as claimed in claim 1, wherein the face side comprises a planar surface.

7. The piezo injector as claimed in claim 1, wherein the face side comprises a convex or concave surface.

8. The piezo injector as claimed in claim 1, wherein the face side and/or the contact area comprises a spherical surface.

9. The piezo injector as claimed in claim 1, wherein the face side and/or the contact area comprises a conical surface.

10. The piezo injector as claimed in claim 1, wherein the nozzle needle opens outwardly.

11. The piezo injector as claimed in claim 1, wherein, the hydraulic coupler unit forms a fuel film with a thickness in the range from 0.01 mm to 0.7 mm, for the purposes of force transmission, between the coupler cylinder and the coupler piston.

12. The piezo injector as claimed in claim 1, wherein a lateral pairing clearance between coupler cylinder and coupler piston amounts to at most 10 μm.
